(19) United States
(12) Patent Application Publication
(10) Pub. No.: US 2021/0168130 A1
(43) Pub. Date: Jun. 3, 2021

(54) INFORMATION PROCESSING APPARATUS, INFORMATION PROCESSING SYSTEM, METHOD OF PROCESSING INFORMATION, AND NON-TRANSITORY RECORDING MEDIUM

(71) Applicant: Taichi WATANABE, Kanagawa (JP)

(72) Inventor: Taichi WATANABE, Kanagawa (JP)

(21) Appl. No.: 17/073,757

(22) Filed: Oct. 19, 2020

(30) Foreign Application Priority Data
Nov. 29, 2019 (JP) 2019-217360

(51) Int. Cl. H04L 29/06; H04N 1/00; H04N 1/44; G06F 3/12

(52) U.S. Cl. CPC H04L 63/083; H04N 1/0097; G06F 3/1285; G06F 3/1222; G06F 3/1238; H04N 1/4413

(57) ABSTRACT

An information processing apparatus includes a network interface and circuitry. The network interface communicates with a service provision system that authenticates a user and generates content screen information. The circuitry displays, on a display, a content screen based on the content screen information acquired from the service provision system and transmits authentication information to the service provision system in response to a first login operation performed by the user. The first login operation is a login operation performed by the user for the first time. The circuitry stores, in a memory, user information, which is acquired from the service provision system in response to authentication of the user in the first login operation, and switches, when the user is to perform a second login operation, the content screen according to the user information. The second login operation includes one or more login operations performed by the user after the first login operation.

### CROSS-REFERENCE TO RELATED APPLICATION

This patent application is based on and claims priority pursuant to 35 U.S.C. § 119(a) to Japanese Patent Application No. 2019-217360, filed on Nov. 29, 2019, in the Japan Patent Office, the entire disclosure of which is hereby incorporated by reference herein.

### BACKGROUND

### Technical Field

Embodiments of the present disclosure relate to an information processing apparatus, an information processing system, a method of processing information, and a non-transitory recording medium storing instructions for executing a method of processing information.

### Related Art

In recent years, web applications represented by, for example, a cloud service, or functions of applications of servers provided as services are used. In general, authentication is required to use such services.

There is a known service that links a document input/output device, such as a Multifunction Peripheral/Product/Printer (MFP) with a computer system that provides a cloud storage service, which rents a storage area for storage through a network.

In addition, there is a web page for setting various settings in the above-mentioned system, and functions regarding such a web page have been appropriately added or improved.

There is a known technique that, on a website, specifies a region to which a user who logs in belongs (a region where a user is) and displays a web page supporting the specified region in order to prompt the user to make a site transition to a corresponding site generated for the region.

Conventionally, for example, when a function regarding a web page is added or improved, such an addition or improvement on the function is often reflected at the same time in all regions where a service is expanded.

### SUMMARY

An exemplary embodiment of the present disclosure includes an information processing apparatus. The information processing apparatus includes a network interface and circuitry. The interface communicates with a service provision system that authenticates a user and generates content screen information. The circuitry displays, on a display, a content screen based on the content screen information acquired from the service provision system and transmits authentication information to the service provision system in response to a first login operation performed by the user. The first login operation is a login operation performed by the user for the first time. The circuitry stores, in a memory, user information, which is acquired from the service provision system in response to authentication of the user in the first login operation, and switches, when the user is to perform a second login operation, the content screen according to the user information stored. The second login operation includes one or more login operations performed by the user after the first login operation.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of an information processing system according to one or more embodiments;

FIG. 2 is a block diagram illustrating an example of a hardware configuration of one of an authentication device and a service provision device according one or more embodiments;

FIG. 3 is a block diagram illustrating an example of a hardware configuration of an electronic apparatus (multifunction peripheral/Product/Printer (MFP)) according to one or more embodiments;

FIG. 4 is a block diagram illustrating an example of a functional configuration, which is related to a web page switching process, of an authentication device, a service provision device, and an electronic apparatus, according to one or more embodiments;

FIG. 5 is an illustration of an example of affiliation information (information for identifying a region) according to one or more embodiments;

FIG. 6 is a diagram illustrating an example of association between region information and countries, which is used to determine in relation to a switching determination process according to one or more embodiments;

FIG. 7 is a sequence diagram illustrating an example of a process of storing affiliation information when a user accesses for the first time, according to one or more embodiments;

FIG. 8 is a sequence diagram illustrating an example of a process of switching a function to be provided when a user accesses again after the first time-accessing, according to one or more embodiments;

FIG. 9 is a flowchart schematically illustrating a flow of a web page switching process according to one or more embodiments;

FIG. 10 is an illustration of an example of a switching screen according to one or more embodiments;

FIG. 11 is a diagram illustrating an example of a modification of a configuration of affiliation information, according to one or more embodiments;

FIG. 12 is an illustration of an example of affiliation information according to one or more embodiments;

FIG. 13 is a sequence diagram illustrating an example of a process of switching a function to be provided based on an Internet Protocol (IP) address according to one or more embodiments; and

FIG. 14 is a diagram illustrating an example of information for managing groups, users, and IP addresses of access sources, according to one or more embodiments.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

Hereinafter, a detailed description is given of several embodiments of an information processing apparatus, an information processing system, an information processing method, and a non-transitory computer-readable recording medium, with reference to the drawings.

### First Embodiment

System Configuration

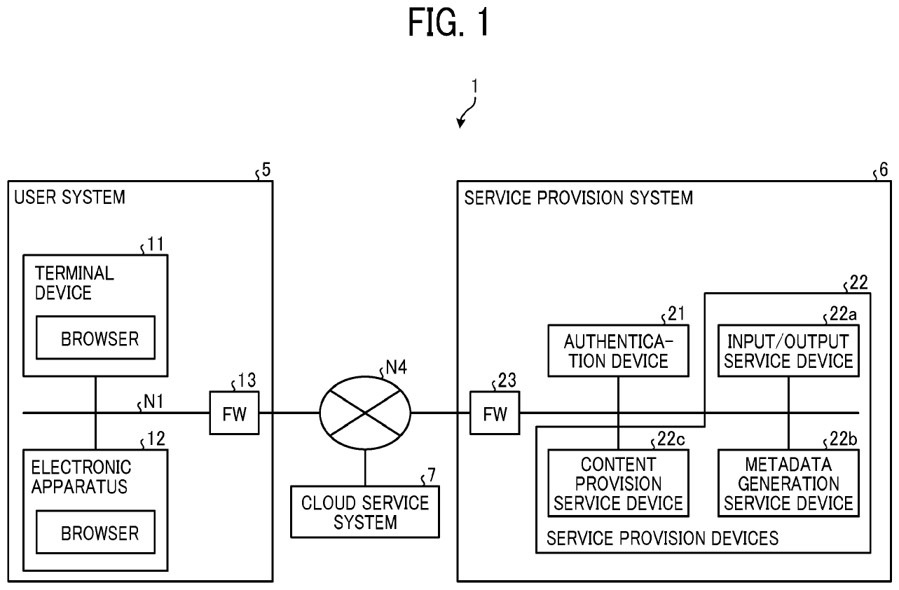

FIG. 1 is a diagram illustrating an example of a configuration of an information processing system 1 according to a first embodiment of the disclosure. As illustrated in FIG. 1, the information processing system 1 includes a user system 5, a service provision system 6, and a cloud service system 7. The user system 5, the service provision system 6, and the cloud service system 7 are connected to each other through a network N4 such as a Local Area Network (LAN) or the Internet.

In the user system 5, a terminal device 11 operated by a user, an electronic apparatus 12 shared by a plurality of users, and a firewall (FW) 13 are connected to each other through a network N1 such as a LAN. The network N1 is connected to the network N4 via the FW 13. The FW 13 detects and blocks unauthorized access. The terminal device 11 and the electronic apparatus 12 are examples of information processing apparatuses (devices).

The number of each of the terminal devices 11 and the electronic apparatuses 12 in the user system 5 illustrated in FIG. 1 is one. However, the number of each of the terminal devices 11 and the electronic apparatuses 12 may be more than one.

The terminal device 11 may be implemented by an information processing device (computer) that is installed with a general-purpose operating system (OS), for example. The terminal device 11 is a device that is operable by a user. Examples of the terminal device 11 includes a tablet terminal, a personal computer (PC), a smartphone, and a mobile phone, for example.

The electronic apparatus 12 is an apparatus that is shared by a plurality of users for use. Examples of the electronic apparatus 12 includes a Multifunction Peripheral/Product/Printer (MFP), a copier, a scanner, a printer, a laser printer, a projector, and an electronic whiteboard, for example. In the present embodiment, the electronic apparatus 12 is an MFP.

On each of the terminal device 11 and the electronic apparatus 12, a browser, which is software used for browsing such as a web page being open to the public on a network such as the Internet, is installed.

For example, the browser installed on the electronic apparatus 12 transmits a scanned image to the service provision system 6, or acquires a file to be printed from the service provision system 6.

In addition, the browser installed on the terminal device 11 transmits a recorded photo or a local file to the service provision system 6, or sets various settings for services of the service provision system 6.

In the service provision system 6, an authentication device 21, one or more service provision devices 22, and a FW 23 are connected to each other through a network N2 such as a LAN. Hereinafter, the one or more service provision devices 22 may be referred to as a service provision device 22. The network N2 is connected to the network N4 via the FW 23. The FW 23 detects and blocks unauthorized access.

Each of the authentication device 21 and the service provision device 22 may be implemented by a computer that is installed with a general-purpose OS, for example. The service provision system 6 is implemented by one or more computers for providing services.

In addition, the authentication device 21 and the service provision device 22 may be implemented by a single computer. Alternatively, the functions or the processes performed by the authentication device 21 and the service provision device 22 may be distributed over multiple computers to implement the authentication device 21 and the service provision device 22.

The authentication device 21 performs a process related to authentication of a user who uses a service of the service provision system 6. Namely, the authentication device 21 authenticates a user for allowing the user to use a service. In addition, the authentication device 21 manages user information and the like.

The service provision device 22 provides various services to the user who is authenticated by the authentication device 21. The service provision device 22 according to the present embodiment includes an input/output service device 22a that provides an input/output service, a metadata generation service device 22b that provides a metadata generation service, and a content provision service device 22c that provides a content provision service. Hereinafter, any one or more of the input/output service device 22a, the metadata generation service device 22b, and the content provision service device 22c may be collectively referred to as the service provision device 22 when being unnecessary to be distinguished from each other.

The input/output service provided by the input/output service device 22a is a service that includes a function of absorbing differences in unique functions (for example adding bibliographic information) in a plurality of cloud storage services, a function of optical character recognition (OCR) processing, and a function of file conversion. The input/output service is implemented by linking the electronic apparatus 12 in a user environment with an application in the service provision device 22.

The metadata generation service provided by the metadata generation service device 22b is a service that defines metadata for generating data to be a request to an input/output service. The metadata generation service is defined by an application developer. The metadata generation service also defines information that indicates which process flow of the input/output service is called by the application.

The content provision service provided by the content provision service device 22c is a service for providing a web page to a user.

The cloud service system 7 provides an existing service in cooperation with an application installed on the electronic apparatus 12, for example. The cloud service system 7 according to the present embodiment provides, for example, a cloud storage service designed in a manner that files are stored and shared on the Internet.

Hardware Configuration of Authentication Device 21 and Service Provision Device 22

A hardware configuration of each of the authentication device 21 and the service provision device 22 is described below.

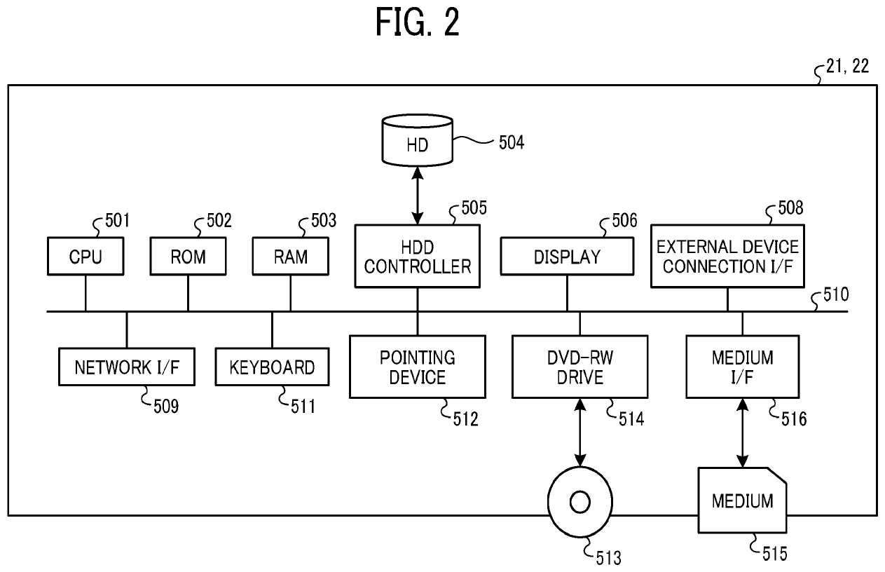

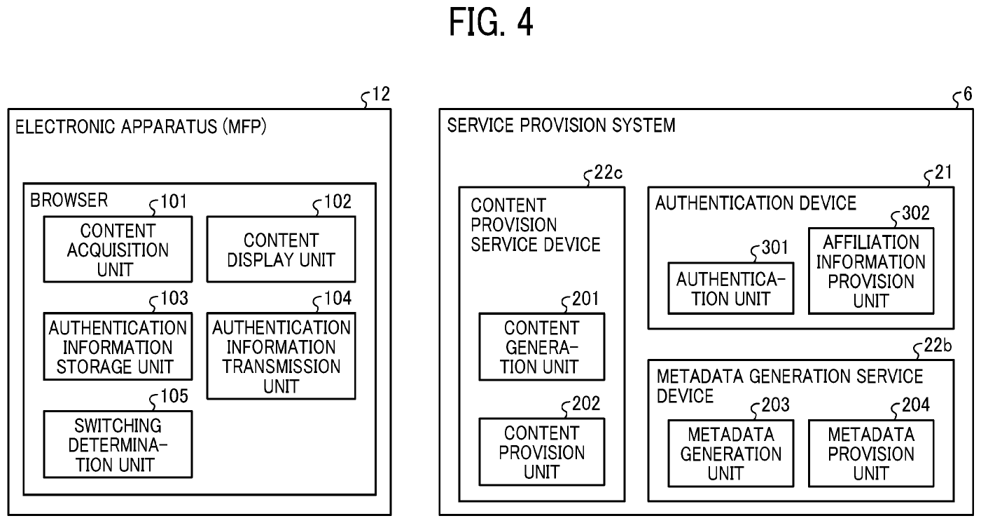

FIG. 2 is a block diagram illustrating an example of the hardware configuration of one of the authentication device 21 and the service provision device 22 according one or more embodiments of the disclosure. Each of the authentication device 21 and the service provision device 22 is implemented by a computer including a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network interface (I/F) 509, a bus line 510, a keyboard 511, a pointing device 512, a digital versatile disc rewritable (DVD-RW) drive 514 and a medium I/F 516, as illustrated in FIG. 4.

The CPU 501 controls the entire operation of a corresponding one of the authentication device 21 and the service provision device 22. The ROM 502 stores a program such as an initial program loader (IPL) used for driving the CPU 501. The RAM 503 is used as a work area for the CPU 501.

The HD 504 stores various data such as a program. The HDD controller 505 reads or writes various data from or to the HD 504 under control of the CPU 501.

Programs stored in each HD 504 make a difference between the authentication device 21 and the service provision device 22. In addition, programs stored in each HD 504 make a difference between the input/output service device 22a, the metadata generation service device 22b, and the content provision service device 22c in the service provision devices 22.

The display 506 displays various information such as a cursor, a menu, a window, a character, or an image. The external device connection I/F 508 is an interface for connecting various external devices. Examples of the external devices include a universal serial bus (USB) memory and a printer. The network I/F 509 is an interface for performing data communication using a network. The bus line 510 is, for example, an address bus or a data bus, which electrically connects the elements such as the CPU 501 illustrated in FIG. 4.

The keyboard 511 is an example of an input device provided with a plurality of keys for allowing a user to input characters, numerals, or various instructions. The pointing device 512 is an example of an input device that allows a user to select or execute a specific instruction, select a target for processing, or move a cursor being displayed.

The DVD-RW drive 514 reads and writes various data from and to a DVD-RW 513, which is an example of a removable recording (storage) medium. The removable storage medium is not limited to the DVD-RW and may be a digital versatile disc-recordable (DVD-R) or the like. The medium I/F 516 controls reading and writing (storing) of data from and to a storage medium 515 such as a flash memory.

A program to be executed on each of the authentication device 21 and the service provision device 22 according to the present embodiment is recorded and provided in a computer-readable recording medium, such as a compact disc-read only memory (CD-ROM), a flexible disk (FD), a compact disc-recordable (CD-R), or a digital versatile disk (DVD), in a file in installable or executable format.

Such a program to be executed on each of the authentication device 21 and the service provision device 22 according to the present embodiment may be stored on a computer connected to a network, such as the Internet, to be downloaded from the computer through a network. Further, such a program executed on each of the authentication device 21 and the service provision device 22 according to the present embodiment may be configured to be provided or distributed through a network such as the Internet.

Further, such a program executed on each of the authentication device 21 and the service provision device 22 according to the present embodiment may be configured to be provided as being preloaded in a ROM and the like.

Hardware Configuration of Electronic Apparatus 12

A hardware configuration of the electronic apparatus 12 is described below. In the description of the present embodiment below, an MFP is used as the electronic apparatus 12, as an example.

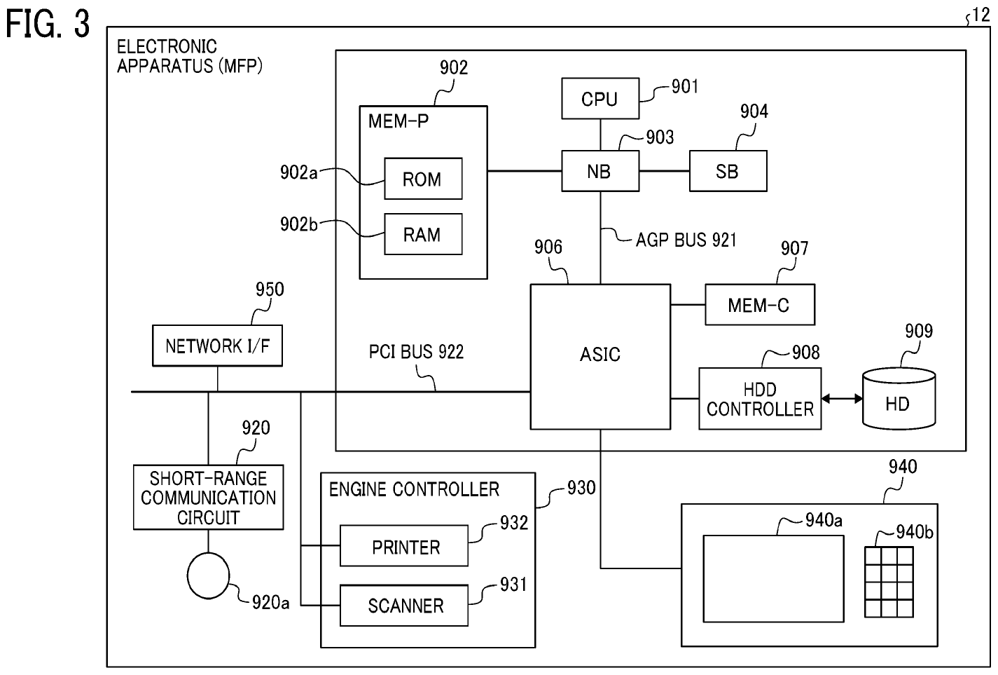

FIG. 3 is a block diagram illustrating an example of the hardware configuration of the electronic apparatus 12 (MFP) according to one or more embodiments of the disclosure. As illustrated in FIG. 3, the electronic apparatus 12 (MFP) includes a controller 910, a short-range communication circuit 920, an engine controller 930, a control panel 940, and a network I/F 950.

The controller 910 includes a CPU 901 as a main processor, a system memory (MEM-P) 902, a north bridge (NB) 903, a south bridge (SB) 904, an application specific integrated circuit (ASIC) 906, a local memory (MEM-C) 907, an HDD controller 908, and an HD 909 as a storage. An Accelerated Graphics Port (AGP) bus 921 connects the NB 903 and the ASIC 906.

The CPU 901 controls the entire operation of the electronic apparatus 12 (MFP). The NB 903 connects the CPU 901 with the MEM-P 902, SB 904, and AGP bus 921. The NB 903 includes a memory controller for controlling reading or writing of various data with respect to the MEM-P 902, a Peripheral Component Interconnect (PCI) master, and an AGP target.

The MEM-P 902 includes a ROM 902a as a memory that stores program and data for implementing various functions of the controller 910. The MEM-P 902 further includes a RAM 902b as a memory that deploys the program and data, or as a drawing memory that stores drawing data for printing. The program stored in the RAM 902b may be stored in any computer-readable storage (recording) medium, such as a compact disc-read only memory (CD-ROM), compact disc-recordable (CD-R), or digital versatile disc (DVD), in a file format installable or executable by the computer, for distribution.

The SB 904 connects the NB 903 with a peripheral component interconnect (PCI) device or a peripheral device. The ASIC 906 is an integrated circuit (IC) dedicated to an image processing use, and connects the AGP bus 921, a PCI bus 922, the HDD controller 908, and the MEM-C 907. The ASIC 906 includes a PCI target, an AGP master, an arbiter (ARB) as a central processor of the ASIC 906, a memory controller to control the MEM-C 907, a plurality of direct memory access controllers (DMACs), and a PCI unit. The DMACs is capable of converting coordinates of image data with a hardware logic. The PCI unit transfers data between a scanner 931 and a printer 932 through the PCI bus 922. The ASIC 906 may be connected to a USB interface, or the Institute of Electrical and Electronics Engineers 1394 (IEEE1394) interface.

The MEM-C 907 is a local memory used as a buffer for image data to be copied or a code buffer. The HD 909 is a storage for storing programs including a browser, various image data, or font data and form data for printing. The HD 909 reads and writes various data from and to the HD 909 under control of the CPU 901. The AGP bus 921 is a bus interface for a graphics accelerator card, which has been proposed to accelerate graphics processing. Through directly accessing the MEM-P 902 by high-throughput, speed of the graphics accelerator card is improved.

Further, the short-range communication circuit 920 includes an antenna for short-range communication circuit 920a. The short-range communication circuit 920 is a communication circuit that communicates in compliance with the near field communication (NFC), the Bluetooth (registered trademark) and the like.

The engine controller 930 includes the scanner 931 and the printer 932. The control panel 940 includes a panel display 940a and an operation device 940b. The panel display 940a is, e.g., a touch panel that displays current settings or a selection screen and that receives a user input. The operation device 940b is constructed of, e.g., a numeric keypad and a start key. The numeric keypad receives assigned values of image forming parameters such as an image density parameter. The start key receives an instruction to start copying. The controller 910 controls the entire electronic apparatus 12 (MFP) and controls, for example, drawing, communication, and input from the control panel 940. The scanner 931 and the printer 932 each performs various image processing, such as error diffusion or gamma conversion.

Note that, in response to an instruction to select a specific application through the control panel 940 by use of, e.g., an application switch key, the electronic apparatus 12 (MFP) sequentially selects function of a document server, coping, printing, and facsimile transmission. The document box mode is selected when the document box function is selected, the copy mode is selected when the copy function is selected, the printer mode is selected when the printer function is selected, and the facsimile mode is selected when the facsimile mode is selected.

The network I/F 950 is an interface to perform data communication using a communication network. The short-range communication circuit 920 and the network I/F 950 are electrically connected to the ASIC 906 through the PCI bus 922.

Functional Configuration of Information Processing System 1

Next, among the various arithmetic processes executed by the CPU 501 of each of the authentication device 21 and the service provision device 22 according to the program and the various arithmetic processes executed by the CPU 901 of the electronic apparatus 12 according to the browser, a web page switching process, which is one of processing features of the present embodiment is described below.

FIG. 4 is a diagram illustrating an example of a functional configuration, which is related to the web page switching process, of the authentication device 21, the service provision device 22, and the electronic apparatus 12, according to one or more embodiments.

As illustrated in FIG. 4, the browser of the electronic apparatus 12 includes a content acquisition unit 101, a content display unit 102, an authentication information storage unit 103, an authentication information transmission unit 104, and a switching determination unit 105.

The content acquisition unit 101 acquires content (for example, hyper text markup language (html), JavaScript (registered trademark), or cascading style sheets (CSS)) from the content provision service device 22c.

The content display unit 102 is a displaying unit for displaying content (content screen information) acquired from the content provision service device 22c.

The authentication information transmission unit 104 is a transmitting unit for transmitting, to the authentication device 21, authentication information used to log in to the content acquired from the content provision service device 22c.

The authentication information storage unit 103 is a storage unit that obtains and stores a result of an authentication process performed by the authentication device 21 and affiliation information (information for identifying a region) based on the result in a predetermined storage area in a local storage of the browser. The affiliation information may be referred to as user information, hereinafter. More specifically, when an existing user successfully logs in to access a web page, the authentication information storage unit 103 identifies the affiliation information (information for identifying a region) which is information on a group to which the user who logs in via the authentication device 21 belongs.

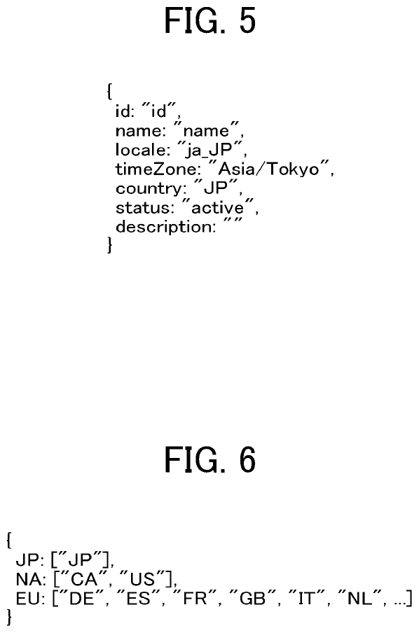

FIG. 5 is an illustration of an example of the affiliation information, or the user information (information for identifying a region) according to one or more embodiments of the disclosure. In FIG. 5, “id” indicates an identification (ID) of a group to which a user belongs, “name” is a name of the group to which the user belongs, “locale” is a language setting used for displaying the affiliation information, and “country” is information indicating which country the group is of.

The authentication information storage unit 103 may extract the affiliation information (information for identifying a region) (“country” in FIG. 5) from the authentication information to set the affiliation information in a cookie.

Although parameters used when the browser accesses the service provision system 6 for identifying a locale of the browser are added, values of such parameters are modifiable by a user. In the present embodiment, using information that is acquired after a login make sure to identify a correct locale.

The switching determination unit 105 determines a region to which a user belongs based on acquired affiliation information (information for identifying a region), and acquires and displays content corresponding to each region from the content provision service device 22c. Further, the switching determination unit 105 may be included in the content provision service device 22c or the metadata generation service device 22b.

FIG. 6 is a diagram illustrating an example of association between region information and countries, which is used to determine in relation to a switching determination process according to one or more embodiments of the disclosure. As illustrated in FIG. 6, information on a region corresponding to each content is set in the content acquired by the browser. The switching determination unit 105 determines which region includes a country of the user based on country information which is the affiliation information (information for identifying a region) as illustrated in FIG. 5. In the example illustrated in FIG. 5, regions of the region information include Japan (JP), North America (NA), and Europe (EU), and one or more corresponding countries are associated with each region of the region information.

In the present embodiment, the switching determination unit 105 of the browser made the determination described above, but this is not limiting. In some embodiments, the content provision service device 22c or the metadata generation service device 22b may hold the information as illustrated in FIG. 6, and the service provision system 6 may make such determination by using the country information transmitted from the browser, which saved the country information, to the service provision system 6.

The content provision service device 22c includes a content generation unit 201 and a content provision unit 202.

The content generation unit 201 is a generating unit for generating content (for example, html, JavaScript, or CSS). The content generation unit 201 may acquire metadata for content from the metadata generation service device 22b and generate the content based on the metadata.

The content provision unit 202 provides the content generated by the content generation unit 201 to the browser of the electronic apparatus 12.

The metadata generation service device 22b includes a metadata generation unit 203 and a metadata provision unit 204.

The metadata generation unit 203 generates metadata used for content or input or output. The metadata provision unit 204 provides metadata that is generated.

The authentication device 21 includes an authentication unit 301 and an affiliation information provision unit 302.

The authentication unit 301 performs authentication for login, for example, based on authentication information transmitted from the browser of the electronic apparatus 12.

The affiliation information provision unit 302 provides to the browser of the electronic apparatus 12 affiliation information indicating a group to which a user authenticated by the authentication unit 301 belongs.

A description is given below of a process of storing affiliation information when a user accesses at the first time.

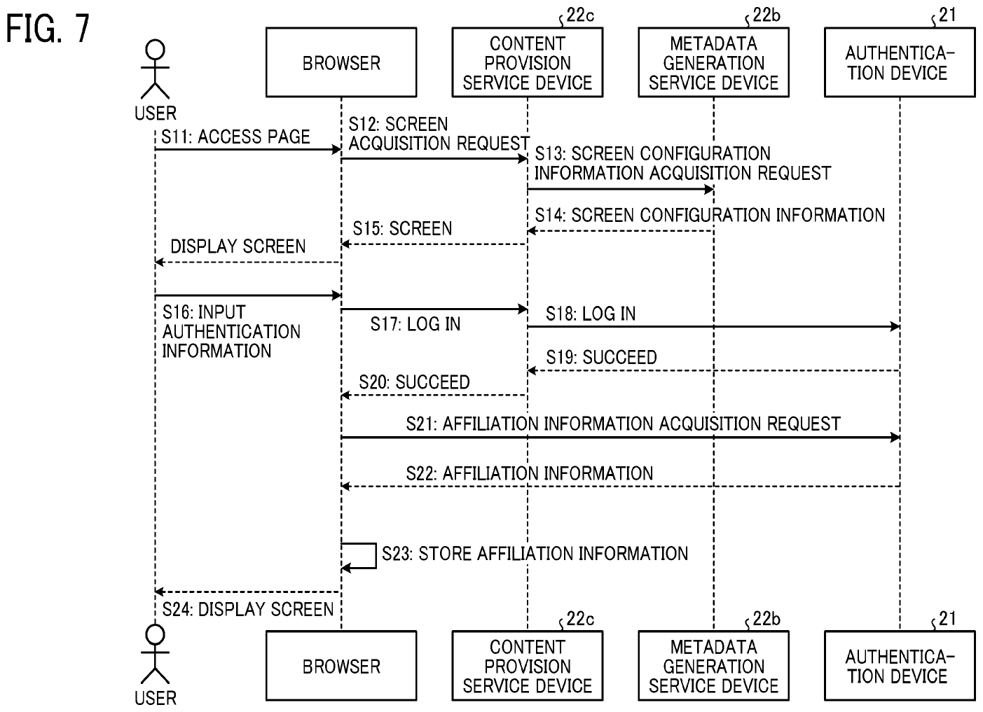

FIG. 7 is a sequence diagram illustrating an example of a process of storing affiliation information when a user accesses for the first time, according to one or more embodiments of the disclosure. When the user inputs a uniform resource locator (URL) to the browser to transition to a web page (step S11), the browser transmits to the content provision service device 22c a screen acquisition request, which is a request for a screen corresponding to a resource that is specified (step S12), and displays a screen for inputting authentication information (an authentication information input screen) (step S15). In the above-described processing, the content provision service device 22c transmits, as necessary, to the metadata generation service device 22 a request for screen configuration information that is to be used for generating an authentication information input screen (step S13), and acquires the screen configuration information from the metadata generation service device 22b (step S14) Hereinafter, the request for screen configuration information may be referred to as a screen configuration information acquisition request.

Subsequently, when the user inputs authentication information on the authentication information input screen displayed on the browser (step S16), the browser transmits the authentication information to the content provision service device 22c for login (step S17). Then, the content provision service device 22c transmits the authentication information to the authentication device 21 (step S18). Namely a first login operation, which is a login operation performed for the first time by a user, is performed by the user.

The authentication device 21 determines whether the input authentication information is correct, and replies the result to the content provision service device 22c (step S19).

When the authentication information is correct, the content provision service device 22c passes to the browser the result indicating that the authentication information is correct, and thereby the login is successful (step S20). Namely the first login operation is successfully performed.

The result indicating that the login is successful is set with an ID identifying a group to which the user belongs, and the browser transmits to the authentication device 21 a request for affiliation information that is associated with the ID of the group (step S21). Hereinafter the request for affiliation information may be referred to as an affiliation information acquisition request. In addition, hereinafter the ID identifying a group may be referred to as a group ID.

The authentication device 21 passes the affiliation information that is based on the group ID to the browser (step S22).

The browser saves, or stores, the affiliation information (see FIG. 5) acquired from the authentication device 21 in a browser local storage (step S23), and then switches the screen to a screen that is specified by the user for displaying (step S24).

A description is now given of a process of switching a function to be provided when the user accesses again after the first time-accessing, namely when the user is to perform a second login operation, which includes one or more login operations performed by the user after the first login operation.

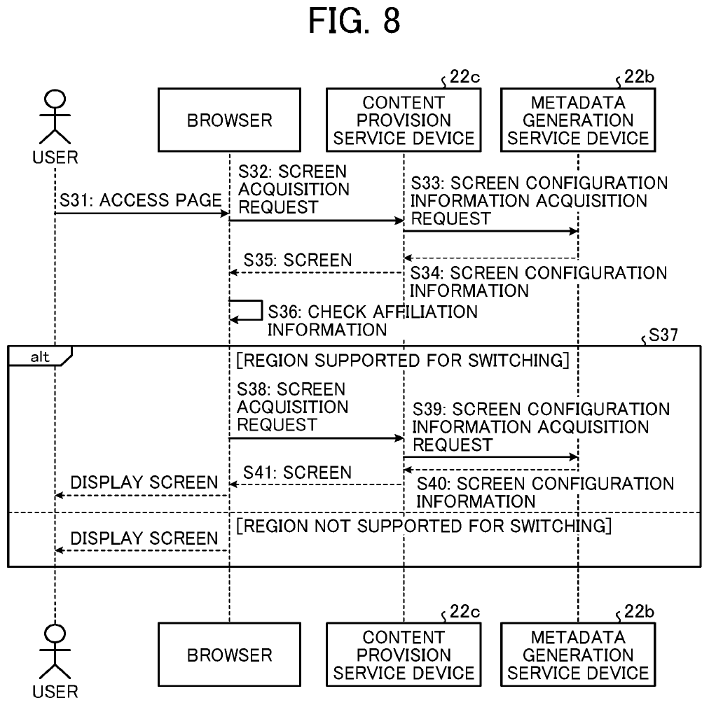

FIG. 8 is a sequence diagram illustrating an example of a process of switching a function to be provided when the user accesses again after the first time-accessing, namely after the first login operation, according to one or more embodiments of the disclosure. When the user inputs the URL to the browser to transition to the web page (step S31), the browser transmits to the content provision service device 22c a screen acquisition request, which is a request for a screen corresponding to a resource that is specified (step S32), and acquires specified content, such as html, CSS, or JavaScript (registered trademark) (step S35). In the above-described processing, the content provision service device 22c transmits, as necessary, to the metadata generation service device 22 a screen configuration information acquisition request, which is a request for screen configuration information that is to be used for generating a content screen (step S33), and acquires the screen configuration information from the metadata generation service device 22b (step S34).

Subsequently, before displaying the content screen, the browser checks the affiliation information (see FIG. 5) stored in the browser local storage (step S36), and executes a web page switching process, which is described later (step S37).

More specifically, the browser transmits a screen acquisition request to the content provision service device 22c when a region indicated by the affiliation information is a region that is supported for switching (region in which a new page is to be displayed) (step S38), and then acquires the specified content (step S41). In the above-described processing, the content provision service device 22c transmits to the metadata generation service device 22 a screen configuration information acquisition request, which is a request for screen configuration information that is to be used for generating a content screen (step S39), and acquires the screen configuration information from the metadata generation service device 22b (step S40).

On the other hand, the browser displays the received content as it is when the affiliation information indicates a region that is not supported for switching.

In the above-described embodiment, conditions to determine whether a region is for switching or not are defined in the resource acquired by the browser. In some embodiments, the conditions may be defined in the metadata generation service device 22b or the authentication device 21, and the browser may make an inquiry for the determination whether the region is for switching or not.

Web Page Switching Process

A description is now given of a process of switching a web page (web page switching process).

The web page switching process in the information processing system 1 according to the present embodiment is a process of switching a displayed web page according to which region a group to which the user belongs is in.

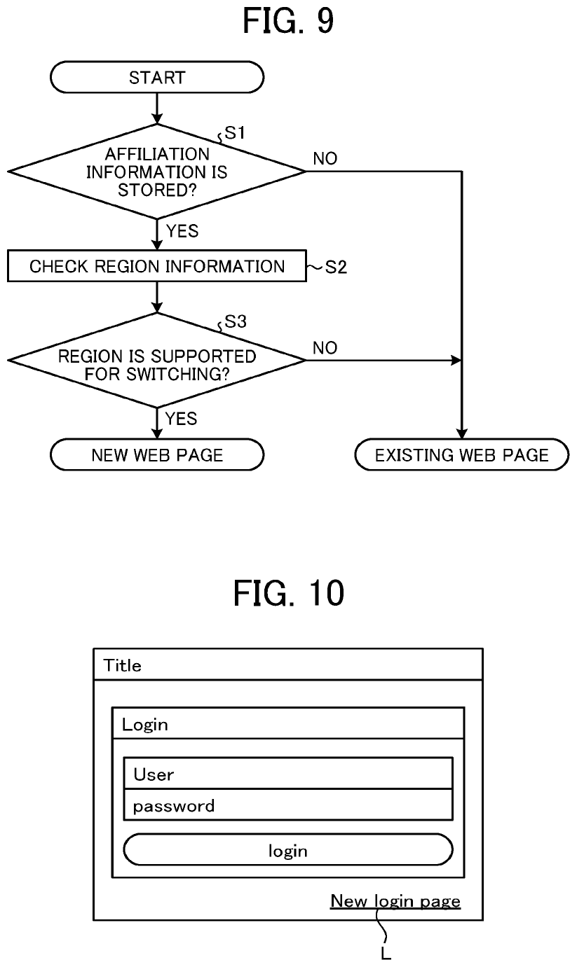

FIG. 9 is a flowchart schematically illustrating a flow of the web page switching process according to one or more embodiments of the disclosure. As illustrated in FIG. 9, when a user accesses a web page, the switching determination unit 105 of the browser of the electronic apparatus 12 determines whether the affiliation information (information for identifying a region) is stored in a predetermined storage area or not (step S1).

When determining that the affiliation information (information for identifying a region) is stored in the predetermined storage area (Yes in step S1), the switching determination unit 105 determines whether a region is a target region for the page switching based on the affiliation information (information for identifying a region) (step S2).

When determining that the user is in the region that is a target for the page switching (Yes in step S3), the switching determination unit 105 displays a new web page (step S4).

On the other hand, when the switching determination unit 105 determines that the affiliation information (information for identifying a region) is not stored in the predetermined storage area (No in step S1), or when the switching determination unit 105 determines that the user is in a region that is not a target for the page switching (No in step S3), an existing web page is displayed (step S5).

As described above, according to the present embodiment described above, when a user logs in to a website, user information identified in response to the login is saved, or stored in the browser, and then when the user logs in to the web site next time (again), information (a content screen) to be displayed is switched, before the login, according to the user information stored in the browser. Accordingly, when a new login page is desired to be displayed to limited users (or areas) in order to change a timing for adding a function to the web page or for reflecting improvement to the web page for each region where the service is expanded (provided), the content screen that is displayed before user login is controllable.

In the embodiment as described above, as illustrated in the flowchart of FIG. 9, when the web page is switched, another web page is displayed by switching the URL as well, but this is not limiting on the disclosure. For example, the content generated by the content provision service device 22c may be dynamically changed so that a user interface (UI) to be displayed is also changed. FIG. 10 is an illustration of an example of a switching screen according to one or more embodiments of the disclosure. In the screen illustrated in FIG. 10, a link L that is capable of transitioning to a new screen is set as “New login page” at the lower right of the illustration. In addition, since a product name may vary depending on a region, a word such as a title may be set as modifiable.

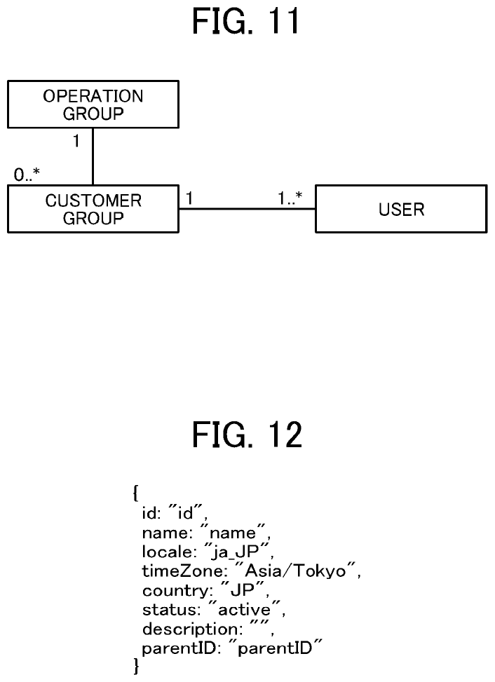

FIG. 11 is a diagram illustrating an example of a modification of a configuration of the affiliation information, according to one or more embodiments of the disclosure. The affiliation information illustrated in FIG. 11 is information on a customer group. A user belongs to the customer group, and the customer group belongs to an operation group. The operation group is a group for generating the customer group, and is a group operated by a developer or sales in a region.

When logging in and succeeding to log in, a user acquires a customer group ID identifying a group to which the user belongs and further acquires customer group information based on the ID.

FIG. 12 is an illustration of another example of the affiliation information according to one or more embodiments of the disclosure. In the affiliation information illustrated in FIG. 12 information for identifying an operation group is added to the affiliation information illustrated in FIG. 5. As illustrated in FIG. 12, information on group is added with a parent ID that identifies an operation group.

According to the present embodiment, the switching determination unit 105 of the browser of the electronic apparatus 12 determines for switching a function by referring to the information (parent ID) for identifying the operation group.

When a function is desired to be provided to a specific group in a case of a verification phase in developing the function, it is possible to provide the function as a trial to specific clients by using, instead of the “region” described above, a group ID or an operation group ID, which is illustrated in FIG. 5 or FIG. 12, of a group to which a user belongs.

### Second Embodiment

A description of a second embodiment is given below.

The second embodiment is different from the first embodiment. More specifically, in the second embodiment, a determination is made based on an Internet Protocol (IP) address of an access source. The IP address of an access source may be referred to as an access source IP address, hereinafter. Hereinafter, in the description of the second embodiment, description of the same part as the first embodiment is omitted and different parts from the first embodiment are described.

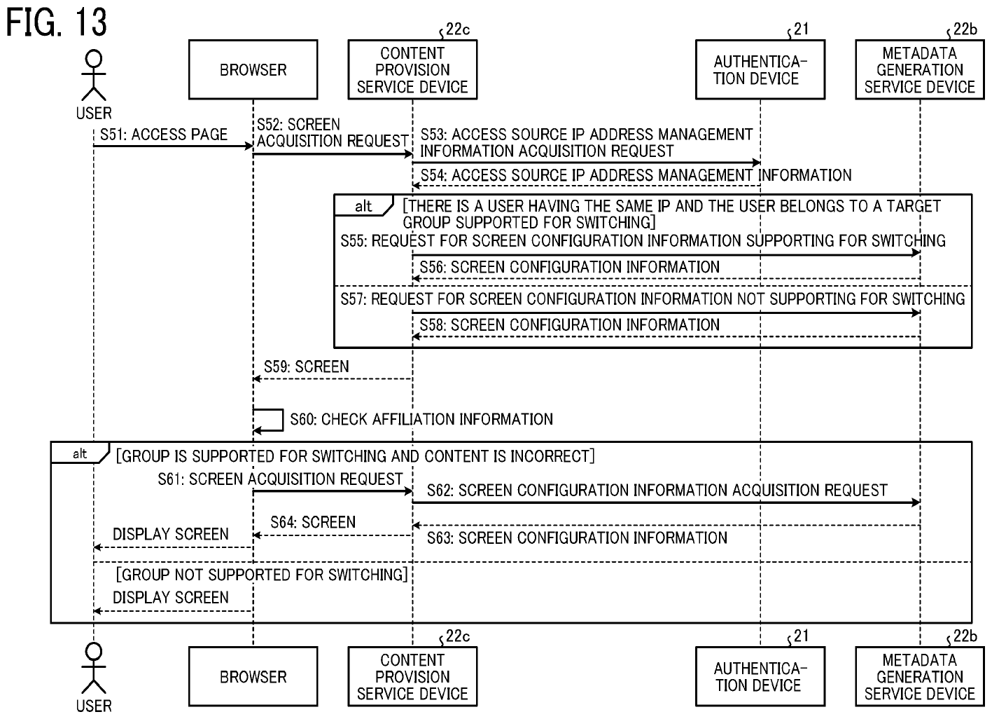

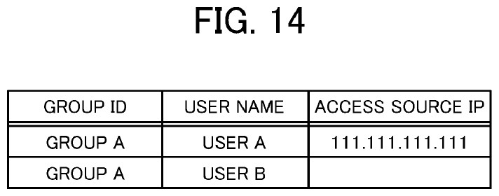

FIG. 13 is a sequence diagram illustrating an example of a process of switching a function to be provided based on an IP address according to the second embodiment of the disclosure. FIG. 14 is a diagram illustrating an example of information for managing groups, users, and access source IP addresses, according to one or more embodiments of the disclosure.

In the second embodiment, even when there is no region information when the browser acquires content in the first embodiment as illustrated in FIG. 8, a determination is made based on an access source IP address.

As illustrated in FIG. 14, for example, it is assumed that there is a user A who has already accessed a web page and a user B who has not accessed the web page before in the same group. When the user A logs in, the authentication device 21 stores an IP address in response to the user A accessing.

When the user B who has not accessed the web page inputs the URL into the browser to transition to the web page (step S51), the browser transmits to the content provision service device 22c a screen acquisition request, which is a request for a screen corresponding to a resource that is specified (step S52).

The content provision service device 22c transmits to the authentication device 21 an access source IP address management information acquisition request, which is a request for access source IP address management information (step S53).

The authentication device 21 transmits the access source IP address management information to the content provision service device 22c in response to the request (step S54).

Subsequently, in the access source IP address management information, when there is a user who has the same IP and when the user having the same IP belongs to a target group supported for switching, the content provision service device 22c acquires from the metadata generation service device 22b screen configuration information (content) corresponding to a screen supporting for switching (steps S55 and S56).

At the same time, the content provision service device 22c acquires screen configuration information (content) that is not supporting for switching from the metadata generation service device 22b (steps S57 and S58).

Then, the browser displays the content acquired from the content provision service device 22c (step S59).

Subsequently, the browser checks the affiliation information saved, or stored, in the browser local storage, before displaying the content screen (step S60).

The browser checks the affiliation information of the user B who has received the content. Because the user B has not accessed the web page before, the affiliation information of user B is not stored in the browser local storage. Accordingly, the browser displays the screen configuration information (content) that is not supporting for switching.

On the other hand, in the access source IP address management information, when the group is supported for switching and when the content is incorrect, the browser transmits a screen acquisition request to the content provision service device 22c (step S61) and then acquires specified content (step S64). In the above-described processing, the content provision service device 22c transmits to the metadata generation service device 22 a screen configuration information acquisition request, which is a request for screen configuration information that is to be used for generating a content screen (step S62), and acquires the screen configuration information from the metadata generation service device 22b (step S63).

On the other hand, the browser displays the received content as it is when the access source IP address management information indicates a group that is not supported for switching.

Since the affiliation information is available after the first time-accessing, namely after the first login operation, whether a page switched based on the access source IP address is correct or not is determined based on, for example, version information. When the switched page is incorrect, information is acquired again in substantially the same manner as in FIG. 8.

Conventionally, for example, when a function is added or improved, such an addition or improvement on the function is often reflected at the same time in all regions. Regarding this, there is a request to change a timing of reflecting such the addition or improvement on the function for each region where the service is expanded.

The known technique is capable of obtaining information for changing the timing for reflecting such the addition or improvement on the function after login. However a web page to be displayed before a user logs in is not able to be changed, or switched. That is, such a technique does not support a case in which changing a web page to be displayed depending on a user is desired.

An object of one or more embodiments of the present disclosure is to allow a user to change, or switch, a content screen to be provided before the user logs in.

According to one or more embodiments of the present disclosure, a content screen to be provided is switchable by a user before the user logs in.

Each of the functions of the described embodiments may be implemented by one or more processing circuits or circuitry. Here, the “processing circuit or circuitry” in the present disclosure includes a programmed processor to execute each function by software, such as a processor implemented by an electronic circuit, and devices, such as an application specific integrated circuit (ASIC), a digital signal processors (DSP), a field programmable gate array (FPGA), and conventional circuit modules arranged to perform the recited functions.

The apparatuses described in the examples are merely an illustration of one of several computing environments for implementing the embodiments disclosed herein. In some embodiments, service provision system 6 includes multiple computing devices, such as a server cluster. The multiple computing devices are configured to communicate with one another through any type of communication link, including a network, a shared memory, etc., and perform processes disclosed herein.

Note that the electronic apparatus 12 is not limited to an image forming apparatus as long as the apparatus has a communication function. The electronic apparatus 12 includes, for example, an output device such as a projector (PJ), an interactive white board (IWB), which is a white board having an electronic whiteboard function capable of mutual communication), a digital signage, a head up display (HUD) device, and an industrial machine, an imaging device, a sound collecting device, a medical device, a network home appliance, an automobile (connected car), a notebook PC, a mobile phone, a smartphone, a tablet terminal, a game console, a personal digital assistant (PDA), a digital camera, a wearable PC or a desktop PC.

Any one of the above-described operations may be performed in various other ways, for example, in an order different from the one described above.

Although the embodiments of the disclosure have been described and illustrated above, such description is not intended to limit the disclosure to the illustrated embodiments. Numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

What is claimed is:

1. An information processing apparatus, comprising:
a network interface configured to communicate with a service provision system that authenticates a user and generates content screen information; and
circuitry configured to
display, on a display, a content screen based on the content screen information acquired from the service provision system,
transmit authentication information to the service provision system in response to a first login operation performed by the user, the first login operation being a login operation performed by the user for a first time,
store, in a memory, user information, the user information being acquired from the service provision system in response to authentication of the user in the first login operation, and
switch, when the user is to perform a second login operation, the content screen according to the user information stored, the second login operation including one or more login operations performed by the user after the first login operation.

2. The information processing apparatus according to claim 1,
wherein the circuitry determines whether the user information is stored in the memory, and
wherein the circuitry switches the content screen according to an Internet Protocol (IP) address of an access source in a case where the user information is not stored in the memory.

3. The information processing apparatus according to claim 1,
wherein the circuitry uses, as the user information, information on a group to which the user belongs.

4. An information processing system, comprising:
the information processing apparatus according to claim 1; and
a service provision system including additional circuitry, the additional circuitry being configured to
authenticate the user, and
generate the content screen information.

5. The information processing system according to claim 4,
wherein the circuitry of the information processing apparatus determines whether the user information is stored in the memory, and
wherein the circuitry of the information processing apparatus switches the content screen according to an IP address of an access source in a case where the user information is not stored in the memory.

6. The information processing system according to claim 4,
wherein the circuitry of the information processing apparatus uses, as the user information, information on a group to which the user belongs.

7. A non-transitory recording medium storing a plurality of instructions which, when executed by one or more processors, cause the processors to perform a method, compri sing:
displaying a content screen based on content screen information acquired from a service provision system, the content screen information having been generated by the service provision system;
transmitting authentication information to the service provision system that authenticates a user in response to a first login operation performed by the user, the first login operation being a login operation performed by the user for a first time;
storing, in a memory, user information, the user information being acquired from the service provision system in response to authentication of the user in the first login operation; and
switching, when the user is to perform a second login operation, the content screen according to the user information stored, the second login operation including one or more login operations performed by the user after the first login operation.

8. A method of processing information, comprising:
displaying a content screen based on content screen information acquired from a service provision system, the content screen information having been generated by the service provision system;
transmitting authentication information to the service provision system that authenticates a user in response to a first login operation performed by the user, the first login operation being a login operation performed by the user for a first time;
storing, in a memory, user information, the user information being acquired from the service provision system in response to authentication of the user in the first login operation; and
switching, when the user is to perform a second login operation, the content screen according to the user information stored, the second login operation including one or more login operations performed by the user after the first login operation.
